(19) United States
(12) Patent Application Publication
(10) Pub. No.: US 2002/0013989 A1
(43) Pub. Date: Feb. 7, 2002

(54) Milling, drilling and grinding machine

(76) Inventor: Samuel Deuschle, Balingen (DE)

Correspondence Address: Eugene LeDonne, Esq., Reed Smith LLP, 17th Floor, 375 Park Ave, New York, NY, 10152, US

(21) Appl. No.: 09/795,586

(22) Filed: Feb. 28, 2001

(30) Foreign Application Priority Data
Mar. 1, 2000 (DE) 200 03 763.3

(51) Int. Cl. B23Q 5/54; B23C 1/00

(52) U.S. Cl. 29/56.5; 409/233; 408/239 R

(57) ABSTRACT

A milling, drilling, and grinding spindle is provided to practically use the space between bearings. The spindle comprises a clamping chuck and a release unit for tensioning and releasing the clamping chuck. The tensioning and releasing is performed for exchanging a tool to be applied in each case. The release unit viewed in the longitudinal direction of the tool spindle is disposed between the clamping chuck and a drive of a shaft, and in particular between bearings of the shaft. The spindle may be motor or belt driven. The release unit may be formed by an integrated pneumatic or hydraulic cylinder and a connecting rod, which can be displaced by means of the cylinder.

### DESCRIPTION

### Prior Art

The invention concerns a milling, drilling or grinding spindle comprising a clamping chuck and a release unit for tensioning and releasing the clamping chuck for exchange of the tool to be applied in each case.

Various methods are known for exchanging tools in milling, drilling or grinding spindles.

In addition to manual tensioning, there have been known automatic tensioning systems for many years comprising a hydraulic or pneumatic cylinder which have the function of compressing the spring packet in the shaft to permit tool exchange. Such a cylinder is also called “release unit”. These known systems are all mounted at the rear side of milling, drilling or grinding spindles and are independent of the bearing of the spindle.

Due to the technical development of milling, drilling and grinding machine drives, the simple spindles with manual tool exchange became more and more complex.

Initially, manual clamping chucks and belt drive were standard for such spindles. Lateron, spindles with integrated drive motor between the bearings were increasingly developed.

Since there was more and more demand for automatic tool exchange systems, the required hydraulic or pneumatic release cylinder was flanged to the spindle end.

### OBJECT OF THE INVENTION

It is the object to find a possibility of making tool spindles for milling, drilling and grinding machines more compact and flexible.

Subject matter and advantages of the invention

This object is achieved by a spindle in accordance with claim 1. The space between the bearings is thereby used in a practical fashion. The outer dimensions of such spindle drives may be smaller which offers the possibility to produce also inexpensive belt drives comprising tool exchange means.

The invention achieves the following essential advantages:

1. More compact construction

2. Improved utilization of available space between the bearings;

3. Facilitated handling through belt drive;

4. Exchange of belts at reduced costs;

5. Exchange of motors at reduced costs;

6. More flexible selection of the motor size=higher performance;

7. More flexible installation due to smaller installation size mainly when using several spindles on one machine.

### DRAWING

The schematic drawing shows two embodiments of the inventive milling, drilling or grinding spindle and of spindles according to prior art which are explained in the following description.

FIG. 1 shows a cross-section of the milling, drilling or grinding spindle according to the teaching of the invention;

FIG. 2 shows a cross-section of a belt-driven milling, drilling or grinding spindle according to the teaching of the invention;

FIG. 3 shows a milling, drilling or grinding spindle according to prior art;

FIG. 4 shows a cross-section of a further milling, drilling or grinding spindle according to prior art.

### DESCRIPTION OF TWO EMBODIMENTS OF THE INVENTION

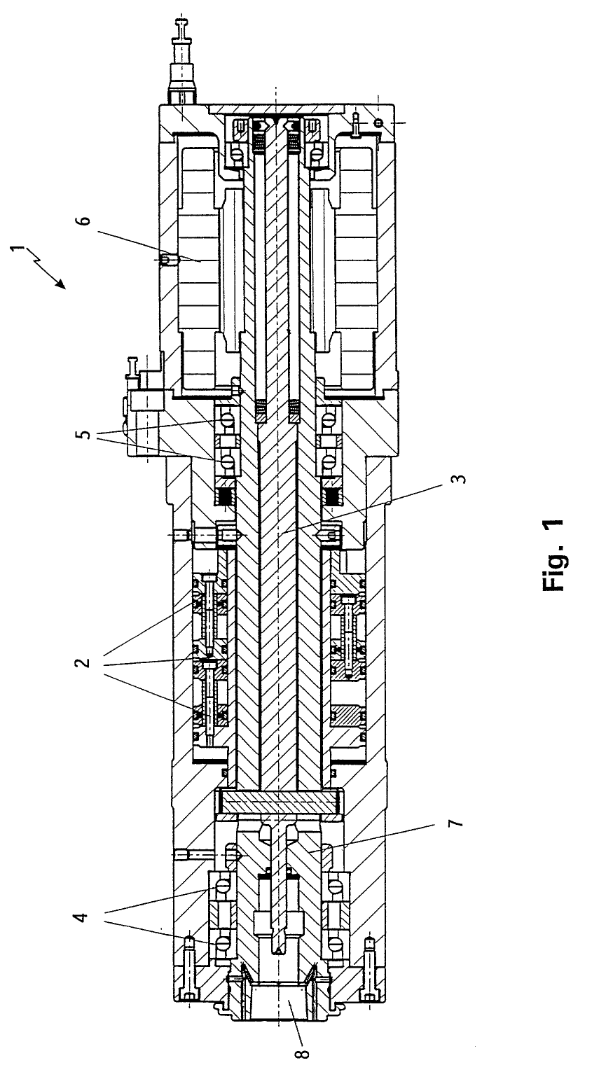

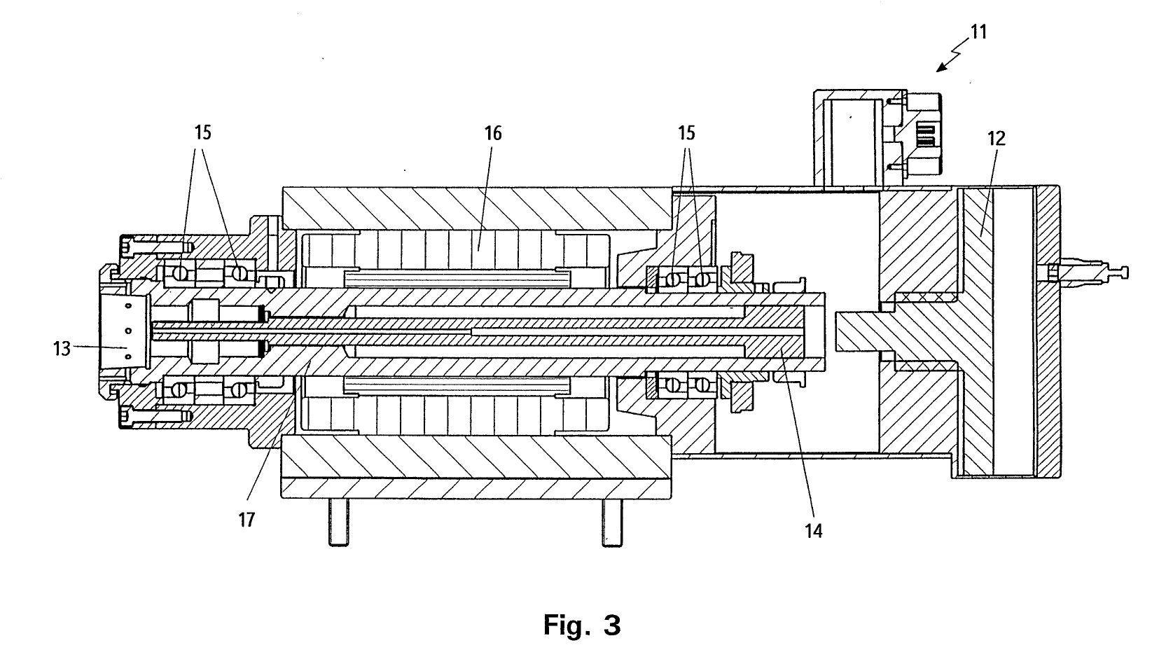

The milling, drilling or grinding spindle 1 according to FIG. 1 considerably reduces the construction size compared to prior art (see FIG. 3). FIG. 1 shows a cross-section of the milling, drilling or grinding spindle 1 with automatic tensioning system and integrated release unit (cylinder 2, connecting rod 3) between the bearings 4 and 5. The drive motor 6 for a shaft 7 is mounted at the rear side facing away from the clamping chuck 8.

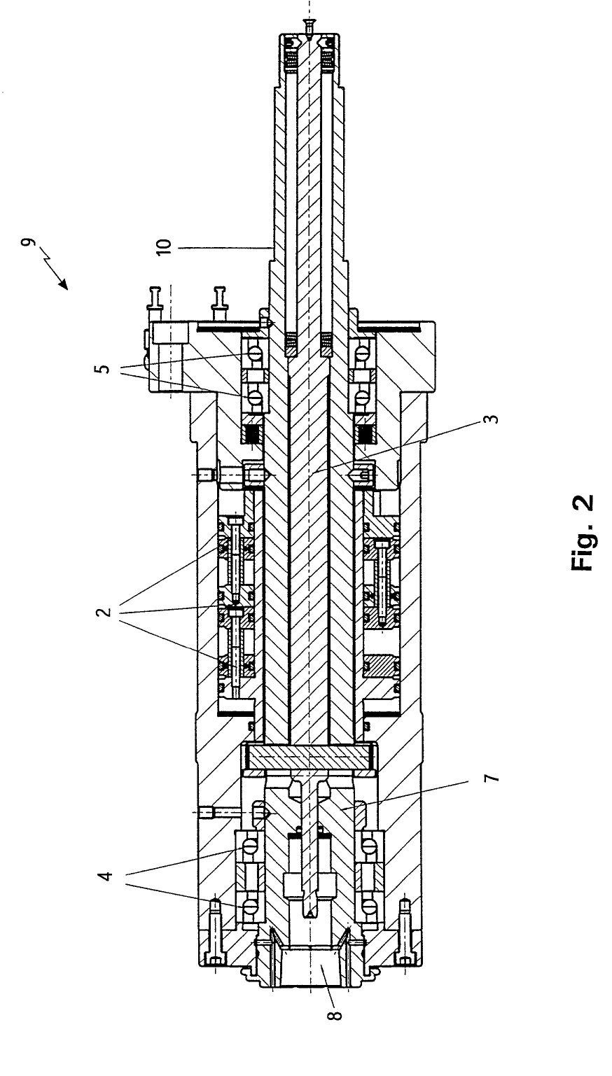

FIG. 2 shows the cross-section of a belt-driven milling, drilling or grinding spindle 9. Structural components which are identical with the milling, drilling or grinding spindle 1 according to FIG. 1 are designated with identical reference numerals. In contrast to FIG. 1, the shaft 7 is driven via a belt (not shown in FIG. 2) which engages on a reception 10. The integrated cylinder 2 of the release unit is disposed between the bearings 4 and 5.

### Description of Spindles According to Prior Art

FIG. 3 shows a milling, drilling or grinding spindle 11 with automatic tool exchange system of a classical type. In this spindle 11, the tool is released by a hydraulic or pneumatic medium which is pressed into the cavity behind the cylinder 12. Pressing of this medium causes the cylinder 12 to move in the direction of the clamping chuck 13 and presses the connecting rod 14 forward in the direction of the clamping chuck 13. In the front extended state of the connecting rod 14, the tool (not shown in FIG. 3) can be removed. FIG. 3 shows exemplarily a cross-section of a milling, drilling or grinding spindle with integrated motor 16 which is disposed between the bearings 14 and 15 for driving the shaft 17 and pneumatic release unit (cylinder 12) which is mounted at the rear side.

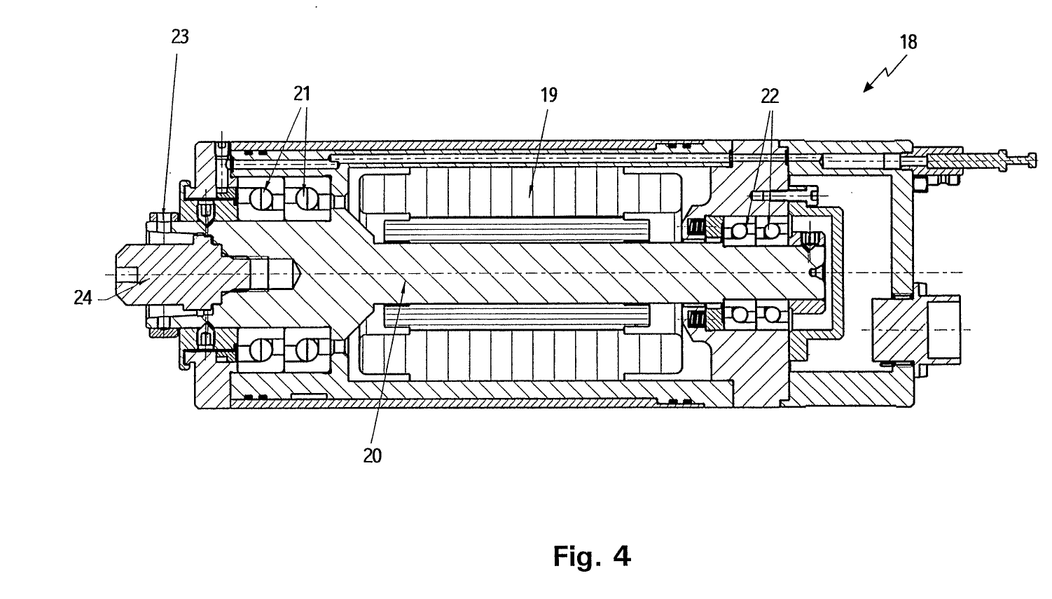

For a better understanding of the invention, FIG. 4 shows a cross-section of a milling, drilling or grinding spindle 18 with manual tool exchange. In the spindle 18 shown, a drive motor 19 is located between the bearings 21 and 22 for driving a shaft 20. To exchange tools, an Allan key is inserted through an access bore 23 and turned to release the tool. The tool may subsequently be removed from the clamping chuck 24. FIG. 4 shows a milling, drilling or grinding spindle 18 with manual tool exchange and integrated motor 19.

### LIST OF REFERENCE NUMERALS

1 milling, drilling or grinding spindle

2 cylinder

3 connecting rod

4 bearing

5 bearing

6 drive motor

7 shaft

8 clamping chuck

9 tool exchange spindle

10 reception

11 milling, drilling or grinding spindle

12 cylinder

13 clamping chuck

14 connecting rod

15 bearing

16 drive motor

17 shaft

18 milling, drilling or grinding spindle

19 drive motor

20 shaft

21 bearing

22 bearing

23 access bore

24 clamping chuck

1. Milling, drilling or grinding spindle (1;9) comprising a clamping chuck (8) and a release unit (2,3) for tensioning and releasing the clamping chuck (8) for exchanging the tool to be applied in each case, characterized in that the release unit (2,3)—viewed in the longitudinal direction of the tool spindle (1;9)—is disposed between the clamping chuck (8) and the drive (6,10) of the shaft (7), in particular between bearings (4,5) of the shaft (7).

2. Spindle according to claim 1, characterized in that it is a motor or belt-driven milling, drilling or grinding spindle (1;9).

3. Spindle according to claim 1 or 2, characterized in that the release unit is formed by an integrated, pneumatic or hydraulic cylinder (2) and a connecting rod (3) which can be displaced by means of the cylinder (2).
